(19) United States
(12) Patent Application Publication
(10) Pub. No.: US 2003/0074400 A1
(43) Pub. Date: Apr. 17, 2003

(54) Web user profiling system and method

(76) Inventors: David Brooks, Guelph (CA); Yang Wang, Waterloo (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/113,405

(22) Filed: Apr. 1, 2002

(30) Foreign Application Priority Data
Mar. 30, 2001 (CA) 2,342,476

(51) Int. Cl. G06F 15/16

(52) U.S. Cl. 709/203

(57) ABSTRACT

A web user profiling system and method. The method includes a profile editor for user-controlled profile creation and management, a web classification tree including a keyword language, the tree providing a hierarchal structure for classifying a user's web behavior, and a web page analysis engine for classifying web pages viewed leveraging the tree. The system further includes a page stream analysis engine for filtering the classified web pages into classification groupings to provide dynamic user profile information, and a profile gateway having a security manager, the gateway providing permissioned remote access to a user's profile.

### FIELD OF THE INVENTION

The present invention relates generally to Internet browsing, and more particularly to a system and method for profiling web users.

1. Background of the Invention

Currently, there is a technology gap in the World Wide Web in the realm of user/vendor interaction. Though countess e-Commerce, personalization and customer relationship management (CRM) applications exist, unsolicited and irrelevant web content and advertising continues to bombard users.

Most current web content analysis techniques used by web behavior analysis function by filtering the words in a web page to find the most relevant subject text and are ill equipped to properly target content and advertising in an accurate and relevant manner. For example, a web site that sells software for PDA's cannot classify in general categories such as “mobile computing”, unless those terms show up in the site. In addition, the algorithms that perform these keyword-relevance functions can be quite complex, precluding their use in real-time applications, or on modestly powered PCs.

Furthermore, in the rush to achieve targeted Internet marketing, user privacy has been routinely violated, resulting in a backlash against such things as browser cookies and server-side profiling platforms. Presently, users typically control their privacy by blocking all e-vendor interaction. This all-or-nothing approach has resulted in large numbers of potential customers remaining on the e-commerce sidelines due solely to very valid privacy concerns. Therefore, a new method is needed for user/vendor interaction that encourages potential customers to become full-fledged consumers.

For the foregoing reasons there is a need for an improved method of profiling web users.

### SUMMARY OF THE INVENTION

The present invention is directed to a web user profiling system and method. The system includes a profile editor for user-controlled profile creation and management, a web classification tree including a keyword language, the tree providing a hierarchal structure for classifying a user's web behavior, and a web page analysis engine for classifying web pages viewed leveraging the tree.

The system further includes a page stream analysis engine for filtering the classified web pages into classification groupings to provide dynamic user profile information, and a profile gateway having a security manager, the gateway providing permissioned remote access to a user's profile.

The method includes the steps of creating and managing a user-controlled profile using a profile editor, classifying a user's web behavior using a hierarchal structured classification tree including a keyword language, and classifying web pages using a web page analysis engine that leverages the tree.

The method further includes the steps of filtering the classified web pages into classification groupings using a page stream analysis engine to provide dynamic profile information, and providing permissioned remote access to a user's profile using a profile gateway having a security manager.

In an aspect of the invention, the system is compiled as a browser plug-in for integration into, and for leveraging the functionality of a browser. in an aspect of the invention, the system further includes one or more complex metrics for monitoring additional patterns formed within the browser. In an aspect of the invention, groupings can be weighted according to established criteria.

The invention can enable a web site to personalize content based not just on a user's local activity, but also on their global Internet activity. This is achieved by leveraging the profiles of users who may never have visited that web site before, providing information immediately without having to develop a new client history.

Furthermore, by remaining at the browser level, rather than the TCP/IP communication layer, the system can interpret advanced behavior beyond simple web content. It can identify when users are purchasing versus simply browsing, and where and when they spend the most time, and filtering out pages not viewed.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is an overview of a web user profiling system in accordance with the present invention;

FIG. 2 is an overview of a web user profiling method in accordance with the present invention;

FIGS. 3a and b are flow diagrams of page stream analysis;

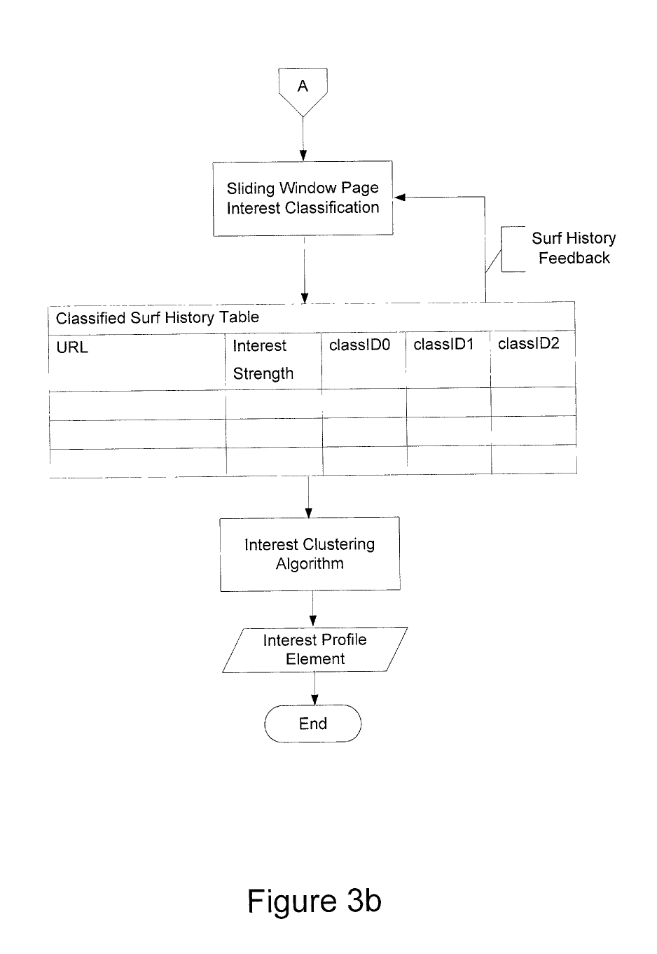

FIG. 4 is a flow diagram illustrating search interest analysis; and

FIG. 5 is a chart illustrating weighting post-processing filtering.

### DETAILED DESCRIPTION OF THE PRESENTLY PREFERRED EMBODIMENT

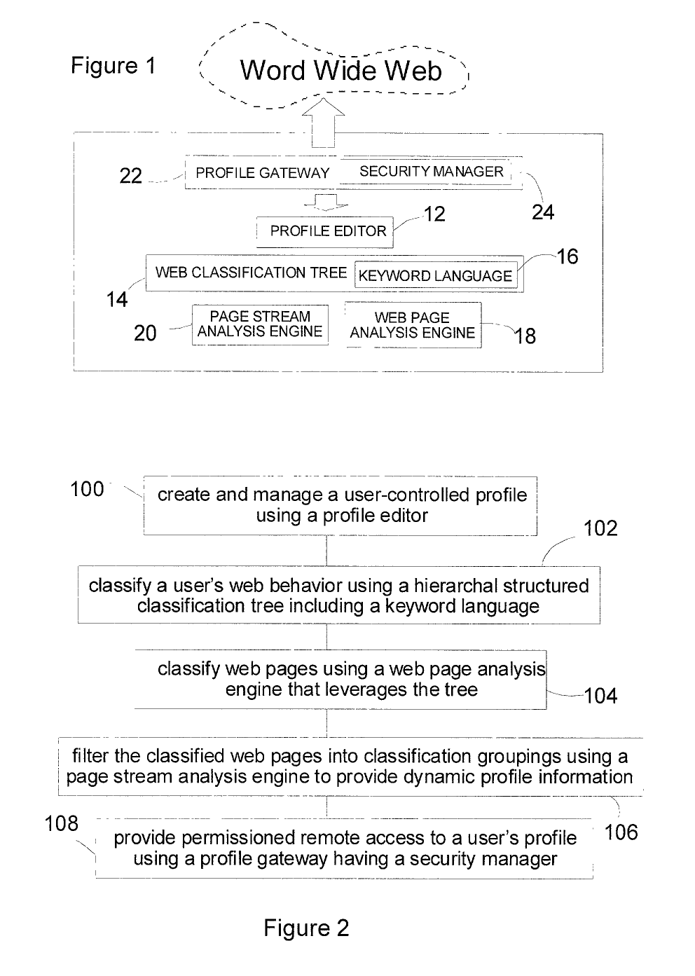

The present invention is directed to a web user profiling system and method. As illustrated in FIG. 1, the system includes a profile editor 12 for user-controlled profile creation and management, a web classification tree 14 including a keyword language 16, the tree 14 providing a hierarchal structure for classifying a user's web behavior, and a web page analysis engine 18 for classifying web pages viewed leveraging the tree 14.

The system further includes a page stream analysis engine 20 for filtering the classified web pages into classification groupings to provide dynamic user profile information, and a profile gateway 22 having a security manager 24, the gateway 22 providing permissioned remote access to a user's profile.

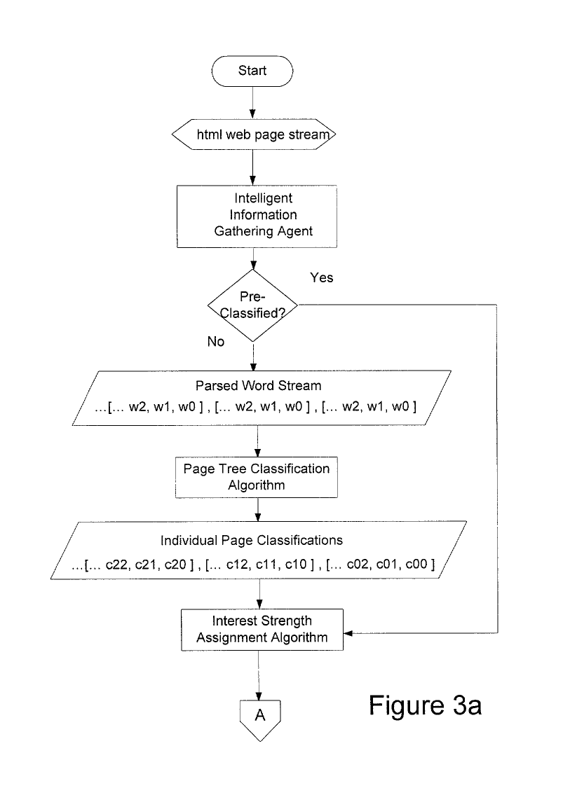

As illustrated in FIG. 2, the method includes the steps of creating and managing a user-controlled profile using a profile editor 100, classifying a user's web behavior using a hierarchal structured classification tree including a keyword language 102, and classifying web pages using a web page analysis engine that leverages the tree 104

The method further includes the steps of filtering the classified web pages into classification groupings using a page stream analysis engine to provide dynamic profile information 106, and providing permissioned remote access to a user's profile using a profile gateway having a security manager 108.

In a preferred embodiment of the present invention, the system is compiled as a lightweight web browser plug-in that can install and run transparently on a common PC within popular Internet browser contexts, avoiding the requirement for a separate invasive installation.

The profile editor 12 is a browser-based user interface that enables the user to manage his or her own profile. The profile editor 12 includes several elements such as opt in/out controls that can target specific portions of the web classification tree 14, thereby achieving a high granularity in privacy control. The profile is an XML document that resides locally on a users computer and provided to a trusted e-vendor in an anonymous manner.

The web page analysis engine 18 is a lightweight web content filtering engine that delivers real-time user profiling within the lightweight operating constraints of a client-side browser environment.

The web page analysis engine 18 differs from other theme and categorization engines such as search portal web crawlers and spiders by combining a broad Internet classification tree and keyword content filter. This provides more relevant summaries of web pages by reducing web site classifications to a targeted and exact user profile.

Using a traditional web analysis engine, a vendor site that sells ‘brand-X’ PDA software might classify the site as ‘brand-X’ or ‘software’. It is unable to classify web pages beyond the subject Keywords contained within them. The web page analysis engine 18 goes much further to identify primary subjects such as ‘Mobile Computing’, ‘PDA's’ and ‘Computers’.

The page stream analysis engine 20 utilizes a dynamic behavioral analysis-filtering algorithm to observe long-term patterns in a user's web activities in order to identify clusters of related topics. This enables the system to better determine which topics are true reflections of a users interests, and which ones are irrelevant.

The page stream analysis engine 20 applies a “clustering” data mining strategy to the complete set of all web page classifications, and reduces irrelevant classifications to create rich user profiles based on elements such as web activity, page content and surf patterns. Furthermore, the page stream analysis engine 20 will recognize disjoint sites as residing in the same topic cluster. It then weighs the aggregate set of related topics to determine the user's interests. Typically, web pages that do not perform within a topic cluster will receive less weighting.

The profile gateway 22 includes a transparent client-side HTTP communication layer that provides a protected channel of communication between a client and a web server for the delivery of a user profile from the client to the server. Access to profiles is provided through direct TCP/IP communication between the web-server and the gateway. The transport is comprised of a compact HTTP protocol that delivers the profile as a standardized XML document. A communication protocol based on XML is provided for the delivery of profiles from the client machine to external web servers.

The gateway 22 utilizes an incorporated security manager 24 to provide protection against the unauthorized creation of server-side profile components, reverse engineering of the gateway, and fraudulent profile tampering. The gateway 22 is responsible for managing the user profile, locally handling requests to update the profile, and providing elements of the profile to trusted web sites visited by the user. The gateway 22 controls both local and remote access to a user's profile and enables permissioned remote access.

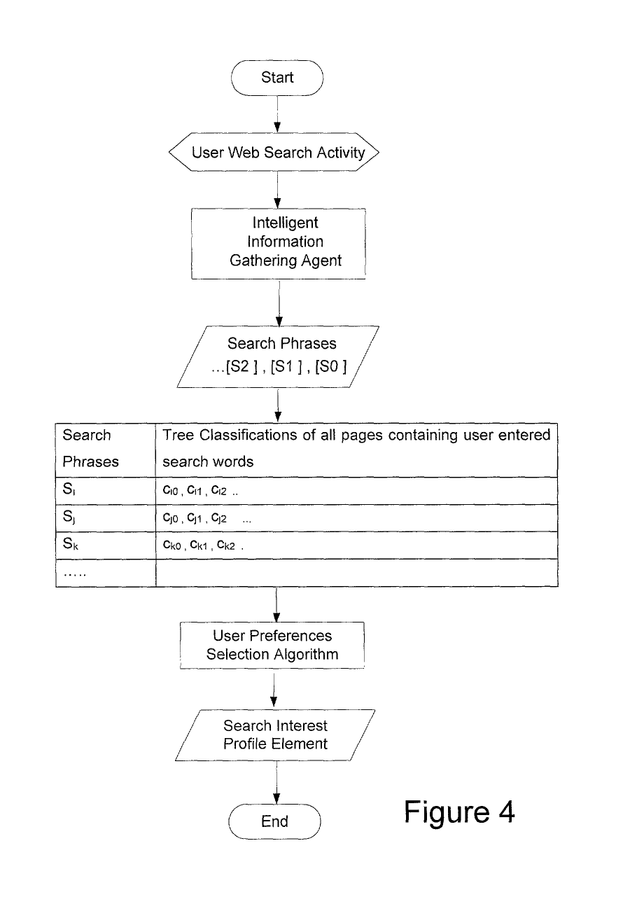

As shown in FIG. 4, the system detects specific user interests based on a user's search phrases. The system leverages the tree 14 to classify all pages containing the search words the user has inputted over time. These classifications are compiled in order to determine the context of those search words. For example, the user may search for “Kodak DC240”. By itself this phrase cannot be classified by the tree 14, but every page that contains these words is clearly about ‘Digital Cameras’. In this way, the system can determine that DC240 is a digital camera based on the individual surfing of the user. Also in this way, the system can determine that DC240 is a personal preference of the user.

In an embodiment of the invention, the system further includes server-side components that incorporate the technology platform. These components can include a web server plug-in, a profile gateway reader or a profile-matching engine that would utilize and manage profiles on a web server.

In an embodiment of the invention, the system further includes one or more complex metrics to provide behavioral analysis of user patterns derives from monitoring usage such as form-fill, viewing duration and recurrence. In an embodiment of the invention, the keyword language 16 further comprises complex rules for providing increased profile accuracy.

In an embodiment of the invention, individual groupings are weighted according to established criteria. In an embodiment of the invention, the system further comprises a temporal analysis filter using time-weighted criteria to sort new pages from typically less relevant old pages.

The Web Classification Tree 14

The web classification tree 14 is a rule-eased classification engine that classifies a web document into a list of pre-defined topics represented by classes, each of which has an associated weight. The output is a “web page summary” in the form of a list of topic/weight pairs representing the content of the web page.

The tree 14 includes a structure that leverages the Open Directory Project (ODP). The ODP's thousands of nodes provide rapid and accurate web page analysis. The system applies associated keyword logic to user profiling, providing keyword and phrase grouping extensions associated with each node. Individual web pages are analyzed on the client machine in real-time, resulting in a subset of nodes from the classification tree 14 incorporated within the profile itself. The resultant classification provides a weighted relevance for each node.

The tree 14 is represented in the form of an array. Each node of the tree represents a unique class for classification, having a number of predetermined classification rules. The tree can be written as {Rᵢⱼ|i=1, 2, . . . m; n=1, 2, . . . , n,}, where m is the number of nodes in the tree and nᵢ is the number of rules for node i. Each element in a node of the tree, called a rule, is an attributed string: Rᵢⱼ={sᵢⱼ,wᵢⱼ}, where sᵢⱼ is a string format word or phrase that signifies which keyword this rule is for, and wᵢⱼ is the weight of this rule.

A document d to be classified is represented by a collection of words: d={(s_{q},ƒ_{q})|qε(1, . . . N)}, where N is the number of words, ƒ_{q} is the occurrence count of word s_{q} in the document. The classification process performs the following computations:

a) Calculating the sum of weights for the document against every possible class, for class i, it is

$${W}_{i} = {\sum }_{q} {\sum }_{j} {w}_{ij} \times {f}_{q} \times E ( {s}_{ij} , {s}_{il} ) ,$$

where function E(s₁,s₂)=0 if s₁≠s₂, and E(s₁,s₂)=1 if s₁=s₂,

b) Eliminating any class candidate with negative/zero weight W₁, or Wᵢ is less than a pre-set threshold;

c) Scaling all weights and output the list of pairs {k, Wₖ|k=1,2, . . . , p} as a web page summary.

The classification engine builds a structure called a “tree” since the information represented is inherently hierarchical. For example, under category Sports. there will be sub-categories, such as Basketball, Football, and Hockey. Under Basketball there will NBA, WNBA and so on. There are many well-developed structures to enable implementing trees in C/C++, as would be known to one skilled in the art. However, all of these structures focus on efficient searching algorithms. In the invention, for any keyword matching, it is inevitable that the tree needs to be spanned. Therefore, a simple array structure is actually faster and uses less memory.

In order to maintain the hierarchy, a type of locator ID forms a virtual tree from the elements in the array. For each element, there is an 8-byte “locator ID” designed to signify the node's location in the virtual tree. The 8-byte locator ID has a similar syntax with an IP address representation, with the exception that a locator ID has eight segments instead of four. For example, the root node of the tree will have locator ID as 0.0.0.0.0.0.0.0. Node “Sports” may be 1.0.0.0.0.0.0.0, its child “Basketball” has the ID 1.1.0.0.0.0.0.0. With such kind of ID, for any node in tree, it would be very easy to quickly locate its parent, siblings or children.

Each node in the tree 14 has an integer type “Class ID”. The tree editor manually assigns this ID when he or she creates a node and composes the rules. The objective of assigning this ID is to maintain the consistency among possibly different versions of local tree files used by different servers and/or clients. Once a Class ID is assigned to a node, it should no longer be used for any other class in any versions of a tree, even if in a later version such a class is removed from the tree. In other words. in the evolution of tree, the maximum value of Class ID is considered to be non-decreasing.

The tree 14 is designed in such a way that any accessing or information exchange with the tree node must be done through Class ID. All valid Class ID's should be a positive number. Class ID 0 is reserved for the root node and for all the nodes that one does not want to show in the classification result by purpose, such as for example, a “DNS error” page.

Each tree node has an unsigned short integer index, called a “node index”. As specified previously, the tree structure is realized by an 8-byte locator ID, while the implementation actually employs an array to hold the nodes. This node index is the index of a node in this array. Internal operations, if possible, all use a node index to access the tree nodes. This is the fastest and easiest way. However, it should be observed that the node index is recommended for internal use only. In different versions of the tree, it is highly likely that the same node index would refer to different tree nodes.

Each tree node will have a number of keywords as its attribute. A keyword can be single word, a phrase, or a combination of keywords with an “AND” relation. Some keywords called “scoring keywords” have a floating-point type weight associate with them. The keywords, as attributes of a node, are matched against a web page to be classified to determine if the page belongs to the class that the node represents. There are four types of keywords: trigger keywords; important scoring keywords; related scoring keywords; and disabling keywords.

A trigger keyword is used in order for a class to be classified for a web page, at least one trigger. keyword, or a combination of the trigger words with “AND” relation should appear in it. An important scoring keyword is used once an important scoring keyword is matched. A score of three is added to the class it belongs; the same score is also accumulated to all of its descendants, such as the matching is propagated down to all descendants. A related scoring keyword is used once a related scoring keyword is matched. A score of one is added to the class it belongs. A disabling keyword is used in order for a class to be classified for a web page. None of the disabling word, or a combination of the trigger words with “AND” relation, should appear in it.

In implementation. the attributes comprise keyword indices instead of keyword strings. All keyword strings are stored in a separate string buffer. This can potentially save computer memory when in the tree 14, since there tend to be a lot of duplicates in keyword strings.

The tree 14 is designed to classify an input web page document. However, the tree classification algorithm is different from most rule-based classification algorithms since the output of the tree is not a single class. Instead, it is a list of classes called a web page summary, with each class in the list corresponding to a topic and having a weight associated with it. Within a list, the weights of different topics are comparable, such as for example the larger the weight, the more related the web page is to the topic.

The topics listed in the web page summary are not exclusive. In other words, each of them is valid in describing the web page. For example, a web page about NBA could yield the following web page summary: {(NBA 4), (Basketball 4), (News 2)}. This means that from the classification rules, the page has about 40% talking about NBA, 40% about general basketball, and 20% about news.

It has been discovered through experimentation that user searching constitutes most of the computing time, as the tree 14 is used for web page summarization. Whenever a word from a web page is input into the tree, the tree has to find all the matches of the word in its attribute list It is impractical in terms of speed if such a search goes through every word in the tree. Therefore, attributes should be properly sorted to enable fast string searching and matching.

In the current implementation of the tree, in order to accelerate the searching, all strings are sorted in two steps. The initial sorting sorts all strings into different segments according to string length. Since in the matching algorithm a shorter input string could match a longer one, such as input “book” and keyword “bookkeeper” in the tree is a match; but not visa versa Therefore, sorting the keyword according to string could potentially eliminate many unnecessary comparisons. For example, if input word is “bookkeeper”, the tree is only required to look for matches for keywords that have lengths longer than 9.

The final sorting is performed for each segment. Within a segment, the strings are sorted in ascendant alphanumeric order. This sorting enables the use of a bisection algorithm for searching. A “relaxation” process is required since word “stemming”, and is performed before keywords are logged into the tree. There could be a number of matches of keywords, even within one section. For example, after stemming, the keyword is in the tree as “educat=”, which represent all words that begin with “edicat”. However, if in the tree there are both “educat=” and “educate”, and if the input word from a web page document is “educate”, both “educat=” and “educate” will be picked up as matches.

There are generally only three steps in the classification process: initialization; content filling; and summarization. The initialization process reads data from the tree file in the tree and resets a number of internal variables.

As shown in Table 1, the first statement defines an object “tree” of class “Tree”. The second line calls the function “readTree( )” to read the tree data. There are two file names provided to the function; either, but not both, could be “NULL”. The tree data reading function will first try to read the second file, which should be a binary 128-bit encrypted file. If this file does not exist or the file name is “NULL”, the function will try to read the first file, which is an ASCII text file containing the tree data. If the operation succeeds, the function will encrypt the data and write into a file with the name given as the second parameter, unless given as “NULL”.

TABLE 1
The Initialization Process

// define The Tree object
Tree tree;
// read in tree data
tree.readTree( “tree6.txt”, “tree6.data” );
// reset everything, to get prepared for new document classification
tree.resetSummary();

It should be known to those skilled in the art that reading the encrypted binary file is much faster than reading the ASCII file, since: 1. The binary file is read block-by-block, while the ASCII file is reading string-by-string and line-by-line, the latter requiring string parsing, and 2. The tree data in the binary file is properly pre-sorted and pre-indexed, precluding the need to further sort the strings and create indices for them.

Adding words from a web page document to the tree is performed simply by calling one function “addKeyword( )”, as shown in Table 2.

TABLE 2
Content Filling Process

char *wordBuffer;
int wordStart, wordEnd;
. . .
// define the Tree object
tree.addKeyword(aWord);
// add a string in character array format,
tree.addKeyword(wordBuffer, wordStart, wordEnd);

“addKeyword( )” takes two types of input, a word in character array format, or a large character array holding all words, with two integers to specify the starting point and the ending point in the array of the word to be added. Use of the latter is recommended since mostly the whole web page document will be stored in a large character array after HTML parsing. It will be faster if adding different words to the tree is simply done by parsing one common character array while constantly changing the starting and ending points.

When a word is added the tree performs searches, and matches this incoming word to all existing rules. If for a class a trigger word or a disabling word is matched, a flag for the class will be set. If for a class there is a scoring word match, a temporary register will accumulate the weight associated with the particular word in this class in the tree.

After all words of a web page document have been fed to the tree 14, the tree is ready to “classify” the page by calling “summerizeTopicsClassID( )”, as shown in Table 3.

TABLE 3
Classifying a Web Page

// maximum number of returned topics
const int MAX_MATCH = 64;
// classID's of returned topics
int “classIDs = new int[MAX_MATCH];
// weights of returned topics
char “weights = new char[MAX_MATCH];
// function return the actual topics in the web page summary
int topicNum = tree.summarizeTopicsClassID( classIDs, weights, MAX_MATCH );

The returned summary is in the form of the Class ID/weight pairs. It should be noted that the caller is responsible to allocate and release memories for the summary.

Internally, the summarization is performed in three steps: 1. Going through all classes, and resetting the accumulated weights to 0 for those classes that have disabling keywords matched, or have none of the triggering keywords matched. 2. Sorting the classes in ascendant order according to the accumulated weights and then selecting the top few classes as output, and 3. Applying a post-processing filter to the output as will be described further below.

The tree 14 can be used for purposes other than summarizing a web page document. As shown in Table 4, the function “suggestNodeClassID( )” returns all topics in the form of their integer Class ID that has attributes matching a given keyword.

TABLE 4
Topic/Keyword Search

const int MAX_MATCH_NUM = 64;
char “word = basket”;
int “classIDs = new int [MAX_MATCH_NUM];
int matchNumber = tree.suggestNodeClassID( aWord, classIDs );

The keyword matching used in this function is a loose matching, so the word “basket” may get a match with the keyword “basketball” in the tree.

As shown in Table 5, the function “nodeDistance( )” gives the distance between two nodes, given in the form of Class ID in the tree.

TABLE 5
Topic Distance

int cID1 = 256;
int cID2 = 361;
double distance = tree.nodeDistance(cid1, cid2);

The distance calculation is relatively simple. In the tree, each virtual arc in the tree that connects to a node, and its parent or its children, will have a prefixed distance. The distance between two arbitrary nodes in the tree is the sum of the total distance from each node to their common parent. The nighest possible common parent will be the root node. As shown in Table 6, this function returns the distance between two web page summaries. Since a web page summary is a representation of a web page, this distance reflects the distance between two web page documents.

TABLE 6
Summary Distance

| | |
|---|---|
| int | *cID1, *cID2; |
| char | “weight1, “weight2; |
| int | numID1, numID2; |

// codes to get web page summary into cID1 & cID2
. . .
double distance = summaryDistance( cID1, weight1, numID1,

cID2, weight2, numID2 );

For the two input web page summaries, the number of topics can be different, and the total sum of weights for each summary can be also different. The computation of the summary distance is based on an unfolded tree node distance, as would be known to those skilled in the art

There are a number of constant variables defined in the tree class that may require changing, depending upon the application domain of the tree, as shown in Table 7.

TABLE 7
Variables Used in the Tree

// pre-defined length, the Tree data should not exceed these limits
const int C_BUFFER_LENGTH = 204800:
const int N_BUFFER_LENGTH = 81920;
const int MAX_NUM_STRINGS = 20480;

C_BUFFER_LENGTH is the total length of keyword string buffer in the form of a large character array, N_BUFFER_LENGTH is the total length of class label string buffer in the form of a large character array, and MAX_NUM_STRINGS is total number of keywords, including all the four types of keywords, in the tree data.

To accelerate the reading of the tree data, the program does not first go through the data to get the actual numbers of the values. Instead, spaces are pre-allocated according to the values given by these constant variables. Then after reading the data, the buffer is re-allocated to the actual length. Therefore, the values of these variables should be larger than the actual value given by the tree data. As well, when the tree data grows, these values may require modification. Relevant constant variables are shown in Table 8.

TABLE 8
Relevant Constant Variables

// constant integers for node weights
const int MAX_TOTAL_WEIGHT = 100;
// the half search range for a word in the sorted list
const int SEARCH_RANGE = 128;
// total maximum number of string matching of a string
const int MAX_MATCH_NUM = 256;
// the number of sub-phrases for ONE matching of an input keyword
const int MAX_SUBPHRASE = MAX_MATCH_NUM;
// maximum length of one word

| | |
|---|---|
| #define MAX_WORD_LENGTH | 64 |
| // maximum length of a line in Tree file | |
| #define MAX_LINE_LENGTH | 2048 |

// threshold number of keywords in a page, over that will stop

| | |
|---|---|
| #define MAX_KEYWORD_NUM | 2048 |

MAX_TOTAL_WEIGHT is used in post-processing, as will be described further below, as the maximum total weight in a web page summary. SEARCH_RANGE and MAX_MATCH_NUM are used when searching for matches of an incoming word with the keywords in the tree data. A search will output at most MAX_MATCH_NUM of matches. If the number of matches is more than this, it is considered that this word is not a keyword, and/or the tree data are not very informative with regards to this word. If the tree has at least one match of the incoming word, the bisection-searching algorithm will return one of them. However, relaxation is required since there are potentially more matches around the Keyword being found. The range of such relaxation is SEARCH_RANGE. MAX_SUBPHASE is the maximum number of phrase matches, for example if the incoming word is part of a phrase in a tree keyword. It is reasonable to set it to MAX_MATCH_NUM.

It has been assumed that in the tree rule data, a keyword, either a single word or a phrase, has a length less than MAX_WORD_LENGTH. As well, for each line in the tree file, which has the rules for a class, it should have a length less than MAX_LINE_LENGTH. If the document is too long, it will not only take more time, but also tend to “flood” the tree, making the result less reliable. MAX_KEYWORD_NUM provides the cut-off threshold for the number of words in a web page document that are to be classified. Therefore, if the document words exceed MAX_KEYWORD_NUM, the tree will stop allowing the adding of more words.

Page Stream Analysis Scaling Page Strength Based on Page Content

The system employs a post-processing filtering algorithm. The purpose of post-processing is to obtain a more meaningful set of weights for the outputted web page summary. The most natural and simple method of performing post-processing filtering is to scale the output in the web page summary such that the sum of the weights In the summary is equal to a pre-selected fixed value, typically 100.

However, if scaling is performed to the output weights only, there will be cases where several web page summaries with have identical topic lists and identical weights, but are not equivalent. This may be caused by different diversities of web page contents. As previously shown, the tree only outputs topics with weights larger than a preset threshold, while those topics with a small weight do not get output. If there are many such small weighted topics, it means that the web page has diversified content.

If one supposes that for two web pages, the tree classifier gives two results summary1={(NBA 4), (Basketball 4), (News 2)} and summary2={(NBA 4), (Basketball 4), (Sports 2), (Newspaper 2). (Reporting 2)} respectively. If our cut-off weight threshold for output is 2. then after the simple scaling the two topic lists will both be {(NBA 50), (Basketball 50)}. However, the first page does have more emphasis on NBA and Basketball. Therefore, scaling of the sum should be performed on all lighted nodes in the tree instead of just those ones that get outputted. Then after scaling the two web page summaries will be summary1={(NBA 40), (Basketball 40)} and summary2={(NBA 28.6), (Basketball 28.6)} respectively, which is more meaningful. Mathematically, the scaling function can be written as

$$f ( x ) = \frac{S}{{\sum }_{i} {W}_{i}} x ,$$

where Wₗ is the weight of i^{th} lighted node in the tree, and S is the preset sum.

Another problem with output scaling is the size of the classifying document. In reality, smaller documents tend to give less reliable data for classification. Therefore, if two web pages have classification result {(NBA 40). (Basketball 40), but the first web page has 500 words while the second has only 20 words, one would say that the first page is more about NBA and Basketball than the second one.

A further post-processing technique is weighting. By applying a weighting function, the reliability of the tree classification result is enhanced. The weighting function applied has two parts, as illustrated by the function ƒ(x)=ƒ₁(x)ƒ₂(x). The first weighting function ƒ₁(x) contributes the factors from the number of keywords in a web page document;

$${f}_{1} ( x ) = 1.0 - \frac{1.0}{{ⅇ}^{n / N}} ,$$

where n is the number of input keywords to the tree, and N is a standard number of keywords that is considered to be small, but on which the tree still works.

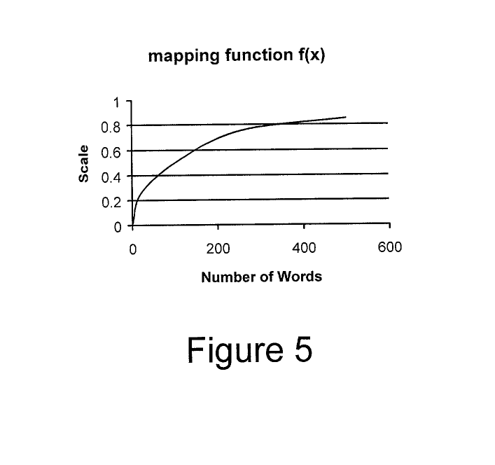

The second weighting function ƒ₂(x) considers the factors from the actual number of the keywords that find matches in the tree versus the number of keywords in the web page document. It has a similar form to the first function

$${f}_{2} ( x ) = 1.0 - \frac{1.0}{{ⅇ}^{\frac{k / n}{r}}} ,$$

where k is the number of keywords that have matches in the tree, n is the total number of input keywords to the tree from the document, and r is a standard ratio of k/n for a web page document. The weighting functions work as filters to justify the strength of the classification, as illustrated in FIG. 5.

Scaling Page Strength Based on Long Term Web User Behavior

A page is represented by a collection of topic-strength pairs, and its viewing time t to be defined, p=[{(IDₗ,Sₗ)|i=0, . . . ,T−1)},r], where T (0≦T<∞) is the number of topics in this page, and

$$0 \leq {\sum }_{i} {S}_{i} \leq S ,$$

where S is a constant for any pages. Currently S=100. If T=0, this page is called an empty page.

The viewing time of a page is defined as the duration from the end of the loading of the page to the start of the loading of the next page. Since a user may remain idle after loading a page, other criteria are applied to determine the actual viewing time, such as mouse movement or other page activity like content interaction.

A page sequence is a list of continuous pages in the order the user surfed the web. It is represented as \overline{P}={Pₗ|i=0, . . . ,M−1}, and Pₗ is surfed before Pₗ if and only if i<j. There is no other page between Pₗ and Pₗ₊₁, M (0<M≦∞) is the total number of pages in the sequence, or sequence length. If M=0, the sequence is considered to be empty.

A sequence subset of a page sequence is called a window, which can be represented as W={Pₗ^{W}|j=0, . . . ,N−1}. The length of the sequence subset, N (N>0), is the size of the window. If N=0, this window is empty Pₗ^{W} is the first page of the window and P_{N}^{W} is the last page, or current page of the window. As interest is only in the pages in one window at one time Pⱼ^{W} is simplified as Pⱼ if not otherwise noticed.

If the current window starts with Pⱼ, the surfing history is a record of the page sequence starting somewhere before Pⱼ₋₁, say Pⱼ₋ₘ (j≧m≧1)and ends at Pⱼ₋₁. It is represented by H=[{(IDₖ,Sₖ)|k=0, . . . ,K},I_{avg}], where K(K>0) is the total number of topics in the history, and Sₖ is the sum of all the strengths of topic IDₖ that appear in the pages of this history sequence. I_{avg} is the average viewing time of all pages in the sequence. If K=0, the surf history is considered to be empty.

A history page, with respect to the current page P_{N} of a window, is a pseudo page that has the same topics as P_{N}, and the strengths of the topics are linearly scaled from those in surf history H to fulfill the requirement of

$${\sum }_{i} {S}_{i} = S .$$

The viewing time of the history page is the average viewing time of all pages in the history.

In a window

$$W = \{ {P}_{j}^{W} \vert j = 0 , … , N - 1 \} ,$$

the weights of the pages are a sequence of real numbers Wⱼ(0≦j<N). A typical setup of the weights is 0≦w₀≦ . . . ≦wⱼ₋₁≦wⱼ≦ . . . ≦w_{N-1}. If the weight of a page is zero, this page is not considered in the window.

Consider a current window, W={Pⱼ|j=0, . . . , N−1} with weights {w_{J}}. The current page is P_{N-1}=[{(IDₗ, Sₗ)|i=0, . . . T_{N-1}−1},t_{N-1}], and the history page is Pₗₗ=[{(IDₗ,S₁^{H})|iₜ=0, . . . ,T_{N-1}−1},r_{H}]. The purpose of scaling is to adjust the strength Sₗ of P_{N-1} according to W,{wₗ},{tₗ} and P_{H}.

Step 1. Scaling topic strengths of each page in the window For each page Pⱼ=[{(IDₗ,Sₗ)|i=0, . . . ,Tⱼ₋₁},tⱼ] replace Sₗ with

$${S}_{t} = S \cdot \frac{{S}_{t}}{{\sum }_{l = 0}^{t - 1} {S}_{k}} .$$

Step 2. Generating history page

$${P}_{H} = [ \{ ( {ID}_{i} , {S}_{i}^{H} ) \vert i = 0 , … , {T}_{N - 1} - 1 \} , {t}_{H} ] , where {S}_{l}^{H} = S \cdot \frac{{S}_{i}}{{\sum }_{j}^{{t}_{dr - 1}} {S}_{j}} ,$$

by picking up topics in the current page P_{N-1}.

Step 3. Scaling topic strengths of the current page

$${S}_{l ( N - 1 )} = r \cdot {λ}_{1} \cdot \frac{{S}_{t}^{H} {t}_{H} + {\sum }_{k = 0}^{N - 1} {S}_{i ( k )} {w}_{k} {t}_{k}}{S \cdot ( 1 + {\sum }_{i = 0}^{N - 1} {w}_{k} ) {t}_{H}}$$

where r is the scaling ratio (set to S normally), Sₗ₍ₖ₎ is the strength of topic Sₗ in page Pₖ, and λₗ is the continuity ratio of pages with topic Sₗ in the window and the window size, calculated by looking up a table. A typical lookup table for a window of three pages is shown in Table 9.

TABLE 9
Scaling Lookup Table

| | | | S₁ in P₂ | |
|---|---|---|---|---|
| # | S₁ in P₀ | S₁ in P₁ | (current) | λ₁ |
| 1 | ✓ | ✓ | ✓ | 10 |
| 2 | ✓ | | ✓ | 8 |
| 3 | | ✓ | ✓ | 5 |
| 4 | | | ✓ | 1 |

S_{l(N-1)} is rounded to the closest integer. Note that history page does not contribute to continuity ratio. It should be noted that all topic strengths in a page are assumed to be positive.

E-commerce companies have already developed powerful web development tools that have succeeded in representing the tailored content paradigm. The invention does not attempt to recreate this existing web-server architecture; instead it intelligently leverages it to deliver profiles based on a user's overall web activity.

The page stream analysis engine 20 removes unwanted content or “noise” in such a manner that user profiles will rarely have more than 10 groupings, even after 10,000 web page viewings.

Users own and control their own profile, determining who can see which elements, if any. From a consumer's point of view, their profile is built and resides on their own computer without requiring any user input They own it and control who can see it. From an e-vendor's point of view, the invention provides an anonymous and current interest-oriented profile delivered by the customer immediately upon arrival at the web site, and without requiring an external network or other costly third party vehicle.

The invention is configurable for implementation within an e-commerce system, and less computing time and resources are required when compared with traditional methods, both with respect to the client side and the vendor side

Furthermore, the invention can enable a web site to personalize content based not just on a users local activity, but on their global Internet activity. This is achieved by leveraging the profiles of users who may never have visited that web site before, providing information immediately without having to develop a new client history.

By remaining at the browser level, rather than the TCP/IP communication layer, the system can interpret advanced behavior beyond simple web content. It can identify when users are purchasing versus simply browsing, and where and when they spend the most time, while filtering out pages not viewed.

Although the present invention has been described in considerable detail with reference to certain preferred embodiments thereof, other versions are possible. Therefore, the spirit and scope of the appended claims should not be limited to the description of the preferred embodiments contained herein.

What is claimed is:

1. A web user profiling system comprising:
a profile editor for user-controlled profile creation and management;
a web classification tree including a keyword language, the tree providing a hierarchal structure for classifying a user's web behavior;
a web page analysis engine for classifying web pages viewed leveraging the tree;
a page stream analysis engine for filtering the classified web pages into classification groupings to provide dynamic user profile information; and
a profile gateway having a security manager, the gateway providing permissioned remote access to a user's profile.

2. The system according to claim 1, compiled as a browser plug-in for integration into, and for leveraging the functionality of a browser.

3. The system according to claim 1, wherein the profile is an XML or other suitably flexible document.

4. The system according to claim 1, wherein the tree is virtual by including locator markers.

5. The system according to claim 1, further including one or more complex metrics for monitoring additional patterns formed within the browser.

6. The system according to claim 1, wherein groupings can be weighted according to established criteria.

7. The system according to claim 1, wherein the keyword language further includes complex rules for providing increased accuracy.

8. The system according to claim 1, wherein the engine further comprises a temporal analysis filter comprising time-weighted criteria to reflect current relevancy.

9. The system according to claim 1, further including one or more user opt in/out controls for opting in or out of specific tree portions of their profile.

10. The system according to claim 1, further including one or more server-side components incorporating the systems technology platform for client-side component interaction.

11. The system according to claim 10, wherein at least one of the one or more server-side components is a web-server plug-in.

12. The system according to claim 10, wherein at least one of the one or more server-side components is a profile gateway reader.

13. The system according to claim 10, wherein at least one of the one or more server-side components is a profile-matching engine.

14. A web user profiling method comprising the steps of:
(i) creating and managing a user-controlled profile using a profile editor;
(ii) classifying a user's web behavior using a hierarchal structured classification tree including a keyword language;
(iii) classifying web pages using a web page analysis engine that leverages the tree;
(iv) filtering the classified web pages into classification groupings using a page stream analysis engine to provide dynamic profile information; and
(v) providing permissioned remote access to a user's profile using a profile gateway having a security manager.

15. The method according to claim 14, compiled as a browser plug-in for integration into, and for leveraging the functionality of a browser.

16. The method according to claim 14, wherein the profile is an XML or other suitably flexible document.

17. The method according to claim 14, wherein the tree is virtual by including locator markers.

18. The method according to claim 14, further including one or more complex metrics for monitoring additional patterns formed within the browser.

19. The method according to claim 14, wherein groupings can be weighted according to established criteria.

20. The method according to claim 14, wherein the keyword language further includes complex rules for providing increased accuracy.

21. The method according to claim 14, wherein the engine further comprises a temporal analysis filter comprising time-weighted criteria to reflect current relevancy.

22. The method according to claim 14, further including one or more user opt in/out controls for opting in or out of specific tree portions of their profile.

23. The method according to claim 14, further including one or more server-side components incorporating the systems technology platform for client-side component interaction.

24. The method according to claim 23, wherein at least one of the one or more server-side components is a web-server plug-in.

25. The method according to claim 23, wherein at least one of the server-side components is a profile gateway reader.

26. The method according to claim 23, wherein at least one of the one or more server-side components is a profile-matching engine.

27. A web user profiling system comprising:
(i) means for creating and managing a user-controlled profile using a profile editor;
(ii) means for classifying a user's web behavior using a hierarchal structured classification tree including a keyword language;
(iii) means for classifying web pages using a web page analysis engine that leverages the tree;
(iv) means for filtering the classified pages into classification groupings using a page stream analysis engine to provide dynamic profile information; and
(v) means for providing permissioned remote access to a user's profile using a profile gateway having a security manager.

28. A storage medium readable by a computer encoding a computer process to provide a web user profiling method, the computer process comprising:
(i) a processing portion for creating and managing a user-controlled profile using a profile editor;
(ii) a processing portion for classifying a user's web behavior using a hierarchal structured classification tree including a keyword language;
(iii) a processing portion for classifying web pages using a web page analysis engine that leverages the tree;
(iv) a processing portion for filtering the classified web pages into classification groupings using a page stream analysis engine to provide dynamic profile information; and
(v) a processing portion for providing permissioned remote access to a user's profile using a profile gateway having a security manager.
